(19) United States
(12) Patent Application Publication
(10) Pub. No.: US 2008/0088139 A1
(43) Pub. Date: Apr. 17, 2008

(54) Door Handle Device for Vehicle

(75) Inventors: Shigeyuki Sunahara, Aichi-ken (JP); Tetsurou Tanimoto, Aichi-ken (JP); Koichi Nagata, Aichi-ken (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/632,827

(22) PCT Filed: Jul. 21, 2005
(86) PCT No.: PCT/JP05/13382

§ 371 Date: Jan. 19, 2007

(30) Foreign Application Priority Data
Jul. 23, 2004 (JP) 2004-215184
Jun. 24, 2005 (JP) 2005-185047
Jun. 27, 2005 (JP) 2005-187069

(51) Int. Cl. E05B 1/02

(52) U.S. Cl. 292/336.3

(57) ABSTRACT

A base member is fixed to a rear surface of a door panel for a vehicle. A grip member is supported on the base member in a tiltable manner. The grip member is arranged on the base member from a front surface of the door panel. A pivot shaft is arranged on the grip member. A shaft supporting member supports the pivot shaft with respect to the base member so that the pivot shaft can pivot relative to the base member. As a result, the grip member is ensurely prevented from becoming loose with respect to the base member in a longitudinal direction of the grip member.

### FIELD OF THE INVENTION

The present invention relates to a vehicle door handle device.

### BACKGROUND OF THE INVENTION

Patent Publications 1 and 2 discuss examples of conventional door handle devices, as will be described later. This door handle will be described with reference to FIG. 20.

The door handle device includes a frame 112 fixed to a rear surface 111b of a door panel 111 for a vehicle, a grip 113 arranged on the frame 112 at a front surface 111a of the door panel 111, and a lever 114 supported on the frame 112 in a pivotal manner. An engagement leg portion 113a is formed on a first end (left end in FIG. 20) of the grip 113 in the longitudinal direction (horizontal direction in FIG. 20). The engagement leg portion 113a is engaged with a support portion 112a arranged on the frame 112. The grip 113 is supported on the frame 112 in a manner tiltable about the engagement leg portion 113a. An engagement arm portion 113b, which is engaged with the lever 114, is formed on a second end (right end in FIG. 20) of the grip 113 in the longitudinal direction. The lever 114 is connected to a rod (not shown) or the like for actuating a door lock device (not shown).

In the state shown in FIG. 20, when the grip 113 is pulled in the outward direction of the vehicle (upward in FIG. 20) with respect to the door panel 111 (opening operation), the grip 113 tilts about the engagement leg portion 113a that is engaged with the support portion 112a of the frame 112 in the outward direction of the vehicle with respect to the frame 112. This operation pivots the lever 114, which is engaged with the engagement arm portion 113b of the grip 113, and unlocks the door lock device, which is connected to the lever 114 to enable the door (not shown) to open.

Patent Publication 1: Japanese Laid-Open Patent Publication No. 2002-4649

Patent Publication 2: Japanese Laid-Open Patent Publication No. 2002-227462

### SUMMARY OF THE INVENTION

In this way, when the opening operation of the door handle device described above is performed, the grip 113 tilts about the engagement leg portion 113a that is engaged with the support portion 112a of the frame 112 in the outward direction of the vehicle with respect to the frame 112. However, the position of the engagement leg portion 113a of the grip 113 is not restricted in the longitudinal direction of the grip 113 with respect to the position of the support portion 112a of the frame 112 supporting the engagement leg portion 113a. In other words, in this structure, the position of the point about which the grip 113 tilts with respect to the frame 112 is not kept constant in the longitudinal direction of the grip 113. More specifically, the engagement leg portion 113a of the grip 113 may move in the longitudinal direction of the grip 113 with respect to the support portion 112a of the frame 112. Thus, when the opening operation of the grip 113 is performed, the grip 113 (grip member) may be loose with respect to the frame 112 (base member) in the longitudinal direction of the grip 113.

It is an object of the present invention to provide a door handle device for a vehicle that ensures prevention of the grip member from becoming loose with respect to a base member in a longitudinal direction of the grip member.

To achieve the above object, a vehicle door handle according to the present invention includes a base member fixed to a rear surface of a door panel for a vehicle and a grip member arranged on the base member from a front surface of the door panel so that the grip member is supported on the base member in a tiltable manner. A pivot shaft is arranged on the grip member. A shaft supporting member supports the pivot shaft with respect to the base member. The shaft supporting member restricts movement of the pivot shaft in the longitudinal direction of the grip member with respect to the base member.

Preferably, the grip member may include a support arm having a pair of opposing walls facing toward each other. The pivot shaft is arranged on the support arm to connect the opposing walls to each other. The shaft supporting member is accommodated between the opposing walls.

Preferably, the shaft supporting member may have a shaft supporting recess for supporting the pivot shaft in a pivotal manner.

Further, a shaft supporting recess for pivotally supporting the pivot shaft may be arranged in the base member.

### BRIEF DESCRIPTION OF THE DRAWINGS

FIG. 1 is a perspective view showing a vehicle door on which a vehicle door handle device according to a first embodiment of the present invention is installed;

FIG. 2 is a cross-sectional view taken along line A-A of FIG. 1;

FIG. 3 is a perspective view showing a support arm of a handle grip included in the vehicle door handle device of FIG. 2;

FIG. 4 is a cross-sectional view showing a support structure of the vehicle door handle device of FIG. 2 in which a fastening piece supports the support arm;

FIG. 5 is a cross-sectional view showing a support structure in which a fastening piece of a modification supports a support arm;

FIG. 6 is a perspective view showing a support arm of a handle grip according to a second embodiment of the present invention;

FIG. 7 is a cross-sectional view showing a support structure in which a fastening piece of the second embodiment supports the support arm of FIG. 6;

FIG. 8 is a cross-sectional view of a door handle device for a vehicle according to a third embodiment of the present invention;

FIG. 9 is a perspective view showing a fastening piece included in a door handle device of FIG. 8;

FIGS. 10(a) and 10(b) are cross-sectional views showing a support structure in which the fastening piece of FIG. 9 supports a pivot shaft of a handle grip;

FIG. 11 is a cross-sectional view taken along line B-B in FIG. 8 showing a state in which the fastening piece of FIG. 9 is temporarily attached to a frame;

FIG. 12 is a cross-sectional view showing a state in which the fastening piece of FIG. 9 is fastened to the frame;

FIG. 13 is a cross-sectional view showing a state in which the fastening piece of FIG. 9 is temporarily attached to the frame with a bolt being loosened;

FIG. 14 is a cross-sectional view showing a state in which the fastening piece of FIG. 9 is temporarily attached to the frame with the bolt being released from a nut;

FIG. 15 is a cross-sectional view of a door handle device for a vehicle according to a fourth embodiment of the present invention;

FIG. 16 is a perspective view showing a guide member included in the door handle device of FIG. 15;

FIG. 17 is a perspective view showing a leg portion of a handle grip included in the door handle device of FIG. 15;

FIGS. 18(a) and 18(b) are cross-sectional views taken along line C-C in FIG. 15;

FIG. 19 is a partially enlarged view showing the main part of FIG. 18; and

FIG. 20 is a cross-sectional view showing the structure of a conventional door handle device.

### DETAILED DESCRIPTION OF THE PREFERRED EMBODIMENT

A first embodiment of the present invention will now be described with reference to the drawings.

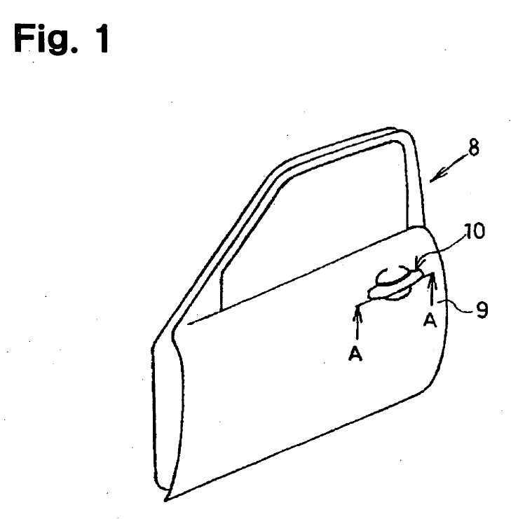

FIG. 1 is a perspective view showing a vehicle door 8. Although the door 8 is described as a side door for a vehicle in the present embodiment, the door 8 is not limited in such a manner and may be a back door for a vehicle. An outside handle device 10 (vehicle door handle) is arranged on an outer panel 9 (door panel) of the door 8. The outside handle device 10 is operated to open and close the door 8 with respect to the body (not shown) of the vehicle.

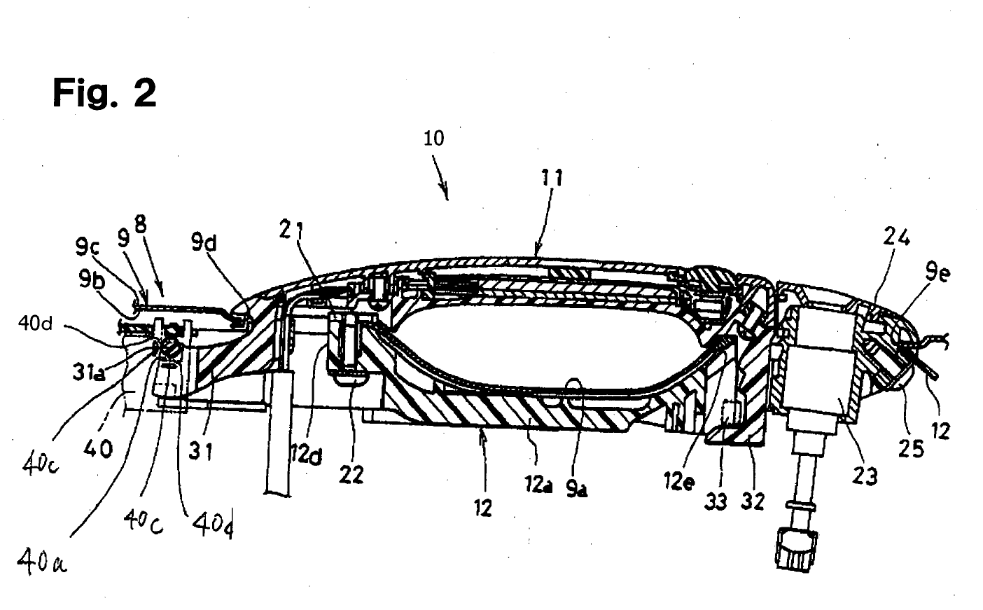

FIG. 2 is a cross-sectional view taken along line A-A in FIG. 1 and shows a state in which the outside handle device 10 is arranged on the outer panel 9 of the door 8.

The outside handle device 10 includes a handle grip 11 (grip member) and a handle frame 12 (base member).

The handle frame 12 includes a curved portion 12a at the middle part in the longitudinal direction (horizontal direction in FIG. 2). The curved portion 12a conforms to a recess 9a formed in the outer panel 9. Two frame openings 12d and 12e are formed on both ends of the handle frame 12 in the longitudinal direction with the curved portion 12a arranged in between. Panel openings 9d and 9e are also formed in the outer panel 9. When the handle frame 12 is fixed to the outer panel 9, the frame openings 12d and 12e are aligned with the panel openings 9d and 9e, respectively.

The two ends of the handle frame 12 in the longitudinal direction with the curved portion 12a arranged in between are fixed to an inner door surface 9b (rear surface) of the outer panel 9. A key cylinder 23 and a cap 24 covering the key cylinder 23 are arranged on the frame opening 12e on the second end (right end in FIG. 2) of the handle frame 12. A screw 25 is arranged on the second end of the handle frame 12. The screw 25 connects the handle frame 12 and the key cylinder 23. When the screw 25 is fastened, the handle frame 12 and the key cylinder 23 hold the outer panel 9 in between. This holding force fastens the second end of the handle frame 12 to the outer panel 9.

The first end (left end in FIG. 2) of the handle frame 12 is fixed to the outer panel 9 by a nut 21 and a screw 22. The nut 21 is configured to hold the outer panel 9 between the nut 21 and the handle frame 12. When the screw 22 is fastened into the nut 21, the nut 21 and the handle frame 12 hold the outer panel 9 in between. This fastens the handle frame 12 to the outer panel 9.

The handle grip 11 is rectangular and includes a support arm 31 and an actuation arm 32.

The actuation arm 32 is formed on the second end (right end in FIG. 2) of the handle grip 11 in the longitudinal direction (horizontal direction in FIG. 2) of the handle grip 11. The actuation arm 32 extends toward the door 8 (downward in FIG. 2). The actuation arm 32 extends through the panel opening 9e of the outer panel 9 into the door 8 and is supported within the frame opening 12e of the handle frame 12. This connects the actuation arm 32 of the handle grip 11 to the door 8. Further, the distal end (lower end in FIG. 2) of the actuation arm 32 is engaged with a bell crank arm 33. The bell crank arm 33 is connected to a door lock device (not shown) arranged within the door 8 by a rod or the like (not shown).

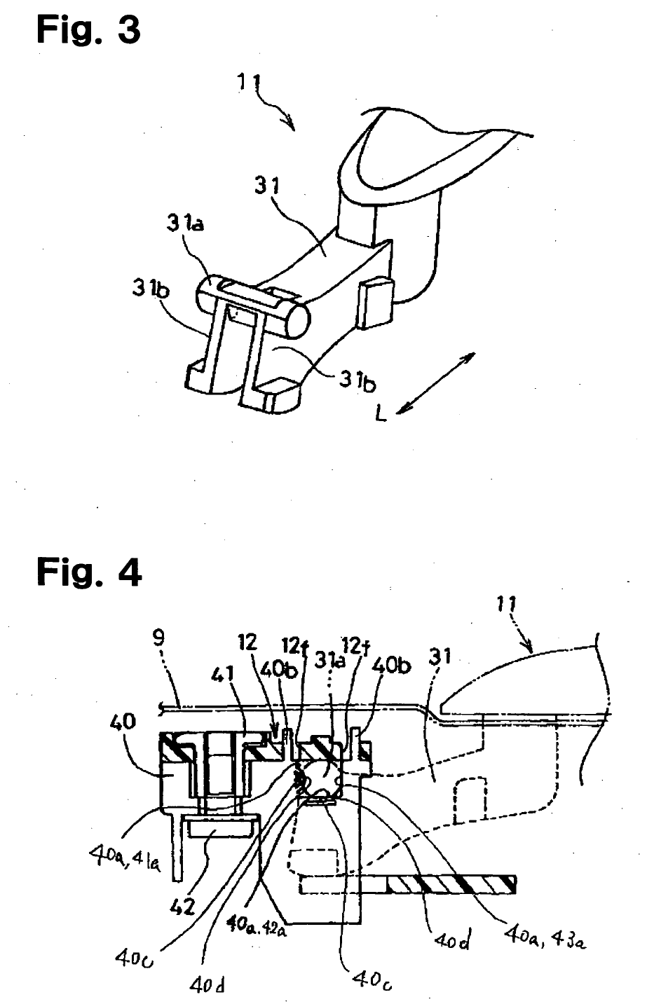

The support arm 31 is formed on the first end (left end in FIG. 2) of the handle grip 11 in the longitudinal direction. The support arm 31 extends through the panel opening 9d of the outer panel 9 into the door 8 and is inserted in the frame opening 12d of the handle frame 12. More specifically, the handle grip 11 is attached to the handle frame 12 at an outer door surface 9c (front surface) of the outer panel 9. A shaft 31a (pivot shaft or tilt shaft) is arranged on the distal end (left end in FIG. 2) of the support arm 31. A fastening piece 40 (shaft supporting member) is arranged within the frame opening 12d of the handle frame 12. The fastening piece 40 supports the shaft 31a in a manner that the support arm 31 is tiltable. This connects the support arm 31 of the handle grip 11 to the door 8. Hereafter, the structure of the shaft 31a for the support arm 31 and the structure of the fastening piece 40 will be described with reference to FIGS. 3 and 4.

FIG. 3 is a perspective view showing the support arm 31 of the handle grip 11. A pair of opposing walls 31b is arranged on the distal end of the support arm 31. The fastening piece 40 (refer to FIG. 2 and FIG. 4) is accommodated between the two opposing walls 31b. The shaft 31a of the support arm 31 connects the two opposing walls 31b. The shaft 31a extends in a direction perpendicular to the longitudinal direction (L direction in FIG. 3) of the handle grip 11 and is cylindrical.

FIG. 4 shows a support structure in which the fastening piece 40 supports the support arm 31. The shaft 31a of the support arm 31 is supported on the handle frame 12 by the fastening piece 40. The fastening piece 40 is fixed to the handle frame 12 by a nut 41 and a screw 42. A support portion 40a (shaft supporting recess) is arranged on the fastening piece 40. The shaft 31a of the support arm 31 is accommodated in the support portion 40a. The support portion 40a is formed as a recess corresponding to the shape of the shaft 31a. The shaft 31a of the support arm 31 is supported on the support portion 40a in a manner that the shaft 31a is rotatable.

The fastening piece 40 has through-holes 40c formed in the vicinity of the support portion 40a. More specifically, the support portion 40a is formed by three inner walls 41a to 43a. The inner walls 41a to 43a are formed to extend in the same direction as the shaft 31a. The through-holes 40c are formed around the support portion 40a. In the present embodiment, two through-holes 40c are formed in a manner that one through hole 40c is located at the side of the inner wall 41a of the support portion 40a (right side in FIG. 4) and the other through hole 40c is located at the side of the inner wall 42a (lower side in FIG. 4). The through-holes 40c are formed to permit the shaft 31a to extend (in the axial direction of the shaft 31a) through the fastening piece 40. The fastening piece 40 has flexible portions 40d corresponding to the through-holes 40c. More specifically, the flexible portions 40d are formed by the through-holes 40c and the inner walls of the support portion 40a. In the present embodiment, two flexible portions 40d are formed by the through-holes 40c and the inner walls 41a and 42a of the support portion 40a. In detail, a portion of the fastening piece 40 (shaft supporting member) between each through hole 40c and the corresponding one of the inner walls 41a and 42a of the support portion 40a (shaft supporting recess) form each flexible portion 40d. The flexible portions 40d come in contact with the shaft 31a. The flexible portions 40d are formed between the through-holes 40c and the support portion 40a so as to form thin portions. As a result, each flexible portion 40d is flexibly deformable in a recessed manner within a predetermined range so as to deform the corresponding through hole 40c. The dimensions of the shaft 31a and the support portion 40a are set in a manner that the flexible portions 40d are constantly deformed to some extent to come in contact with the shaft 31a when the shaft 31a is accommodated in the support portion 40a. More specifically, dimensional differences between the shaft 31a and the support portion 40a are absorbed by the through-holes 40c and the flexible portions 40d. This prevents the support arm 31 from loosening with respect to the fastening piece 40. The through-hole 40c and the flexible portion 40d may be formed on at least one of the inner walls 41a to 43a of the support portion 40a.

Further, a pair of guide portions 40b is arranged on the fastening piece 40. A pair of attachment holes 12f corresponding to the pair of guide portions 40b is arranged on the handle frame 12. To fix the fastening piece 40 to the handle frame 12, the guide portions 40b are inserted through the attachment holes 12f in a state in which the shaft 31a of the support arm 31 is accommodated in the support portion 40a. At this point, the fastening piece 40 is positioned with respect to the handle frame 12 in the longitudinal direction of the handle grip 11. In this state, the fastening piece 40 is fixed to the handle frame 12 by the nut 41 and the screw 42. As a result, the shaft 31a of the support arm 31 is supported on the handle frame 12 in the longitudinal direction of the handle grip 11. In other words, the position of the shaft 31a with respect to the fastening piece 40 in the longitudinal direction of the handle grip 11 is restricted. More specifically, the handle grip 11 is configured to be tiltable about the shaft 31a of the support arm 31 in the outward direction of the vehicle (upward in FIG. 4) with respect to the handle frame 12.

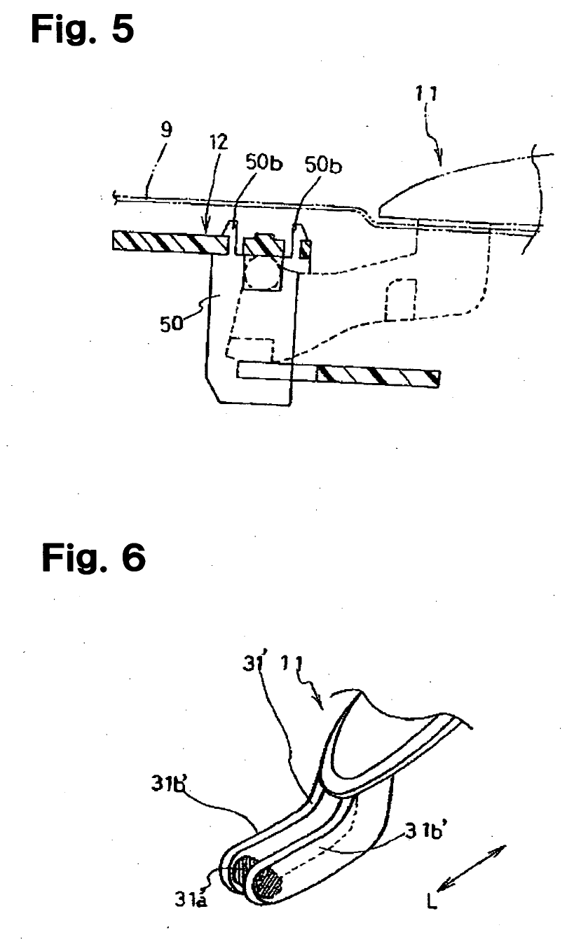

Although the fastening piece 40 is fixed to the handle frame 12 by the nut 41 and the screw 42 in the above-described example, a structure for fixing a fastening piece 50 to a handle frame 12 should not be limited to this structure. For example, as shown in FIG. 5, distal portions of two guide portions 50b of the fastening piece 50 may be formed into hooks, and the guide portions 50b may be engaged with the handle frame 12. In this case, the fastening piece 50 is fixed to the handle frame 12 without using the nut 41 and the screw 42 shown in FIG. 4. Thus, the fastening piece 50 is easily attached to the handle frame 12. Further, the structure of the fastening piece 50 is simplified.

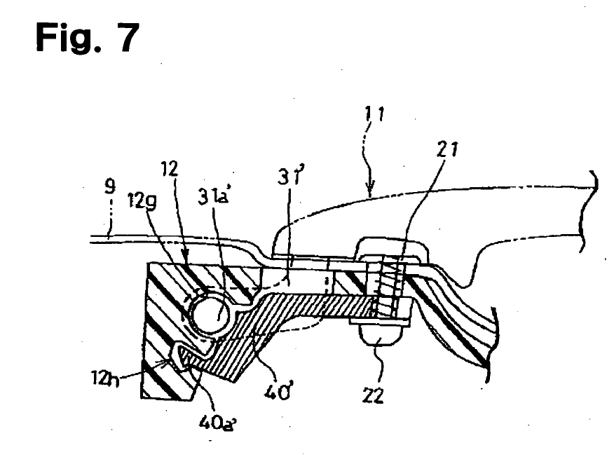

A second embodiment of the present invention will now be described with reference to FIGS. 6 and 7. The second embodiment differs from the first embodiment in the structure of the support arm 31 of the handle grip 11 and the support structure in which the handle frame 12 supports the shaft 31a of the support arm 31. The other components of the second embodiment are common to the first embodiment, and the common components will not be described in detail.

FIG. 6 is a perspective view showing a support arm 31′ of a handle grip 11. A pair of opposing walls 31b′ is arranged on the support arm 31′. A fastening piece 40′ (shaft supporting member) (refer to FIG. 7) is accommodated between the two opposing walls 31b′. A shaft 31a′ (tilt shaft) is arranged on the distal end of the support arm 31′ to connect the two opposing walls 31b′. The shaft 31a′ extends in a direction perpendicular to the longitudinal direction of the handle grip 11 (L direction in FIG. 6) and is cylindrical.

FIG. 7 shows a support structure in which the fastening piece 40′ supports the support arm 31′. The shaft 31a′ of the support arm 31′ is supported on the handle frame 12 by the fastening piece 40′. The shaft 31a′ of the support arm 31′ is accommodated in the support portion 12g (shaft supporting recess) arranged on the handle frame 12. The support portion 12g is formed as a recess corresponding to the shape of the shaft 31a′. The shaft 31a′ of the support arm 31′ is supported so that it is rotatable about the support portion 12g.

A first end (right end in FIG. 7) of the fastening piece 40′ is fixed to the handle frame 12. In the present embodiment, a nut 21 and a screw 22 (refer to FIG. 2) fasten the fastening piece 40′ to an outer panel 9 together with the handle frame 12. In this way, the fastening piece 40′ is fixed to the handle frame 12.

A second end (left end in FIG. 7) of the fastening piece 40′ is engaged with the handle frame 12 by a guide hook 40a′. To fix the fastening piece 40′ to the handle frame 12, the guide hook 40a′ is first engaged with an engagement portion 12h of the handle frame 12 while the shaft 31a′ of the support arm 31′ is accommodated in the support portion 12g. At this point, with the fastening piece 40′ preventing the support portion 12g from coming out, the fastening piece 40′ is positioned with respect to the handle frame 12 in the longitudinal direction of the handle grip 11. In this state, the fastening piece 40′ is fixed to the handle frame 12 by the nut 21 and the screw 22. As a result, the shaft 31a′ of the support arm 31′ is supported on the handle frame 12 in the longitudinal direction of the handle grip 11. In this case, the position of the shaft 31a′ with respect to the fastening piece 40′ in the longitudinal direction of the handle grip 11 is restricted. More specifically, the handle grip 11 is configured to be tiltable about the shaft 31a′ of the support arm 31′ in the outward direction of the vehicle (upward in FIG. 7) with respect to the handle frame 12.

The operation of the outside handle device 10 will now be described briefly with reference to FIG. 2.

To open the door 8, a hand is placed in a space formed between the handle grip 11 and the outer panel 9 to pull the handle grip 11 in the outward direction of the vehicle (upward in FIG. 2). As a result, the handle grip 11 tilts about the shaft 31a of the support arm 31 in the outward direction of the vehicle with respect to the handle frame 12. The actuation arm 32 of the support arm 31 is moved in the outward direction of the vehicle to actuate the bell crank arm 33 that is engaged with the actuation arm 32. This actuates a latch mechanism (not shown) of the door lock device and enables the door 8 to open with respect to the body of the vehicle.

As described above, in the outside handle device 10 of the present invention, the shaft 31a arranged on the support arm 31 of the handle grip 11 is held on the handle frame 12 by the fastening piece 40 in the longitudinal direction of the handle grip 11. As a result, the position of the shaft 31a of the handle grip 11 with respect to the handle frame 12 in the longitudinal direction of the handle grip 11 is restricted. More specifically, the position of the point about which the handle grip 11 tilts with respect to the handle frame 12 is kept constant in the longitudinal direction of the handle grip 11. This ensures that the handle grip 11 is prevented from becoming loose with respect to the handle frame 12 in the longitudinal direction of the handle grip 11. As a result, the operational feel of the handle grip 11 associated with actuation of the door 8 is improved, and the merchantability (quality) of the outside handle device 10 is enhanced.

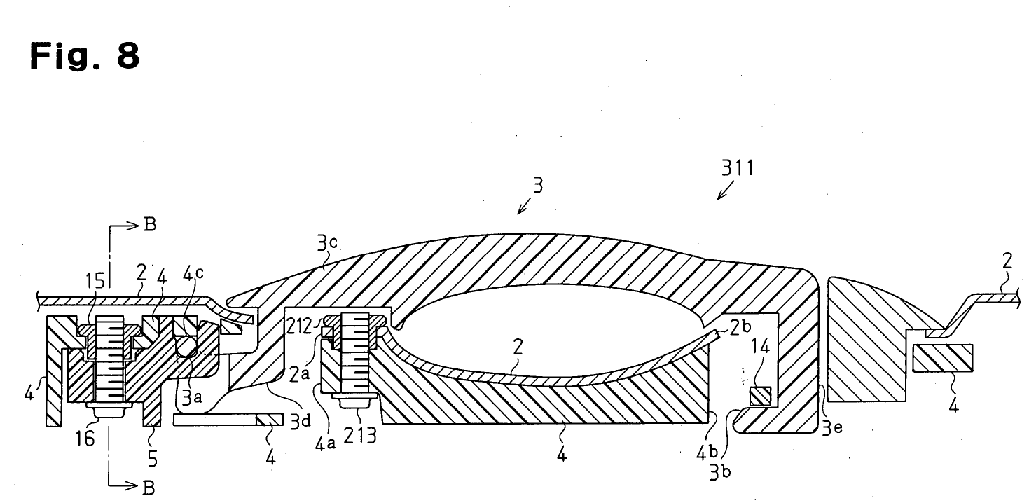

A vehicle door handle device according to a third embodiment of the present invention will now be described. As shown in FIG. 8, a handle grip 3, which functions as a grip when opening a vehicle door, is arranged on a vehicle door panel 2. A door handle device 311 for a vehicle includes a frame 4 arranged inside the door panel 2, the handle grip 3 arranged outside the door panel 2, and a fastening piece (shaft supporting member) 5 fixed to the frame 4.

The frame 4 extends in the forward and rearward direction of the vehicle and is fixed to the door panel 2 by a nut 212 and a bolt 213. The frame 4 has two openings 4a and 4b arranged on both ends of the frame 4 in the longitudinal direction of the frame 4. The door panel 2 has openings 2a and 2b arranged at positions corresponding to the openings 4a and 4b of the frame 4.

The handle grip 3 has an elongated outer shape. The handle grip 3 has a first end (left end in FIG. 8) on which a pivot shaft 3a that is supported on the frame 4 in a pivotal manner is arranged and a second end (right end in FIG. 8) on which an interlocked portion 3b that is interlocked with a door lock mechanism is arranged. The pivot shaft 3a of the handle grip 3 is arranged on a distal end of a leg portion 3d arranged to extend from a first end of an external portion 3c, which serves as a main body of the handle grip 3. The leg portion 3d of the handle grip 3 is inserted in the opening 2a of the door panel 2 and the opening 4a of the frame 4, and the pivot shaft 3a of the handle grip 3 is held by a support portion 4c arranged on the frame 4.

The interlocked portion 3b of the handle grip 3 is arranged on a distal end of a leg portion 3e arranged to extend from a second end of the external portion 3c. The leg portion 3e of the handle grip 3 is inserted in the opening 2b of the door panel 2 and the opening 4b of the frame 4, and the interlocked portion 3b of the handle grip 3 is engaged with a bell crank arm 14. The bell crank arm 14 is connected to the door lock mechanism (not shown) arranged inside the door panel 2.

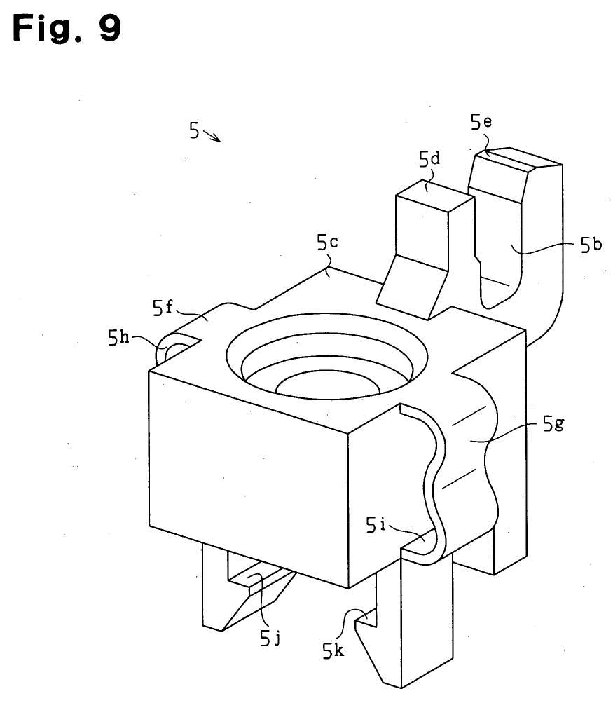

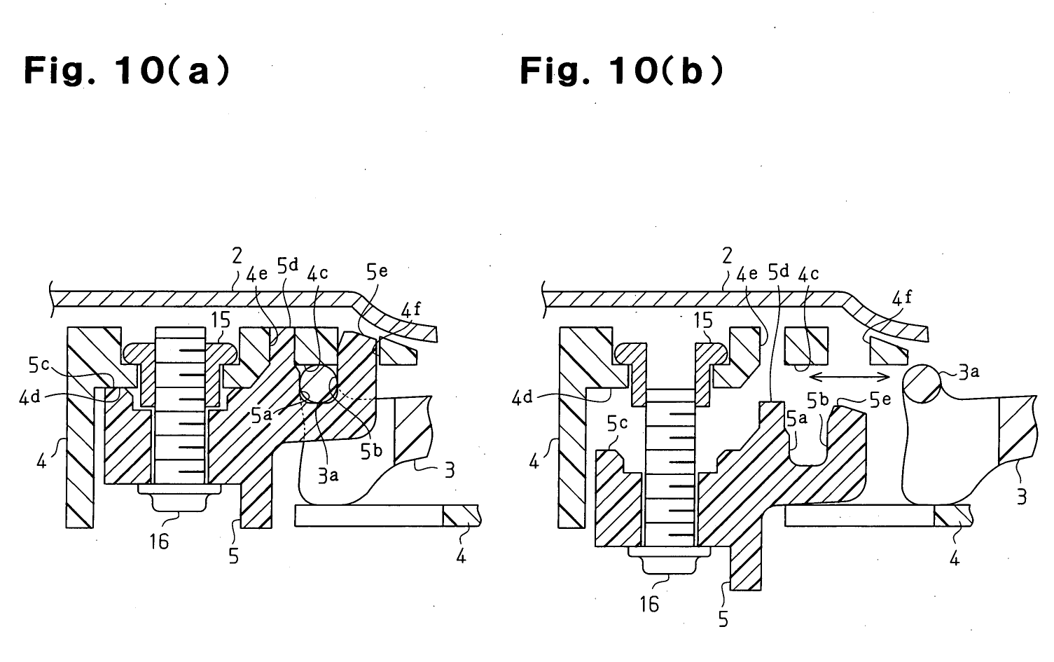

The fastening piece 5 is arranged in the vicinity of the support portion 4c of the frame 4 and configured to restrict movement of the pivot shaft 3a in the longitudinal direction of the handle grip 3 (hereafter may simply be referred to as longitudinal direction). FIG. 9 is a perspective view showing the fastening piece 5, and FIG. 10 is a cross-sectional view showing a support structure in which the fastening piece 5 of FIG. 10 supports the pivot shaft 3a of the handle grip 3. The fastening piece 5 is set in a fastened state shown in FIG. 10(a) when the assembling processes of the door handle device 311 are completed and may be set in a tentatively assembled state shown in FIG. 10(b) during the assembling processes. In the fastened state shown in FIG. 10(a), the fastening piece 5 is fastened to the frame 4 by a nut (female screw portion) 15 and a bolt (fastening member or male screw member) 16. In the tentatively assembled state shown in FIG. 10(b), the fastening piece 5 is supported by the frame 4 at a position separated from the position at which the fastening piece 5 is fixed to the frame 4 (at a position spaced from the position of the fastened state).

The fastening piece 5 includes support portions 5a and 5b having substantially U-shaped cross-sections for accommodating the pivot shaft 3a of the handle grip 3. In the fastened state, the fastening piece 5 is fixed to the frame 4 in the manner described below. The nut 15 is fixed to the frame 4. When the bolt 16 is fastened with the nut 15 that is fixed to the frame 4, a contact surface 5c of the fastening piece 5 and a contact surface 4d of the frame 4 come into contact with each other. Guide portions 5d and 5e of the fastening piece 5 are inserted in openings 4e and 4f of the frame 4 to position the support portions 5a and 5b. As a result, the support portions 5a and 5b of the fastening piece 5 restrict movement of the pivot shaft 3a in the longitudinal direction. Further, the support portion 4c of the frame 4 and the support portions 5a and 5b of the fastening piece 5 support the pivot shaft 3a of the handle grip 3 in a pivotal manner.

In the tentatively assembled state, the fastening piece 5 is released from the nut 15 and the bolt 16 is released, and the contact surface 5c of the fastening piece 5 and the contact surface 4d of the frame 4 are spaced from each other. In this state, the guide portions 5d and 5e of the fastening piece 5 are disengaged from the openings 4e and 4f of the frame 4, and the pivot shaft 3a of the handle grip 3 is not supported by the support portions 5a and 5b of the fastening piece 5. Thus, the pivot shaft 3a of the handle grip 3 is movable in the longitudinal direction (direction indicated using a solid line in FIG. 10(b)), and the handle grip 3 is removable from the frame 4.

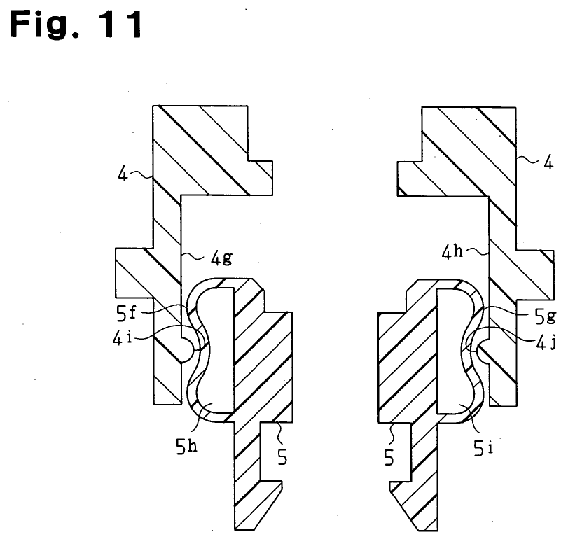

A support structure in which the fastening piece 5 is supported by the frame 4 in the tentatively assembled state of the fastening piece 5 will now be described. FIG. 11 shows a support structure in which the frame 4 supports the fastening piece 5 in the tentatively assembled state. FIG. 11 is a cross-sectional view taken along line B-B in FIG. 8. The frame 4 has projections 4i and 4j that are respectively arranged on flat surfaces 4g and 4h, which face each other and extend in the direction in which the bolt 16 is fastened (vertical direction in FIG. 11). The fastening piece 5 has temporary attachment recesses 5f and 5g respectively formed on flat surfaces that face the flat surfaces 4g and 4h of the frame 4. Hollow portions 5h and 5i are respectively formed inside the temporary attachment recesses 5f and 5g in a manner that walls defining the temporary attachment recesses 5f and 5g are easily and elastically deformed inwards. When the projections 4i and 4j are engaged with the temporary attachment recesses 5f and 5g as shown in FIG. 11, the fastening piece 5 is held on the frame 4 in a temporarily attached state. Since the walls defining the temporary attachment recesses 5f and 5g of the fastening piece 5 are easily deformed, the fastening piece 5 is released from the tentatively assembled state without applying a large load.

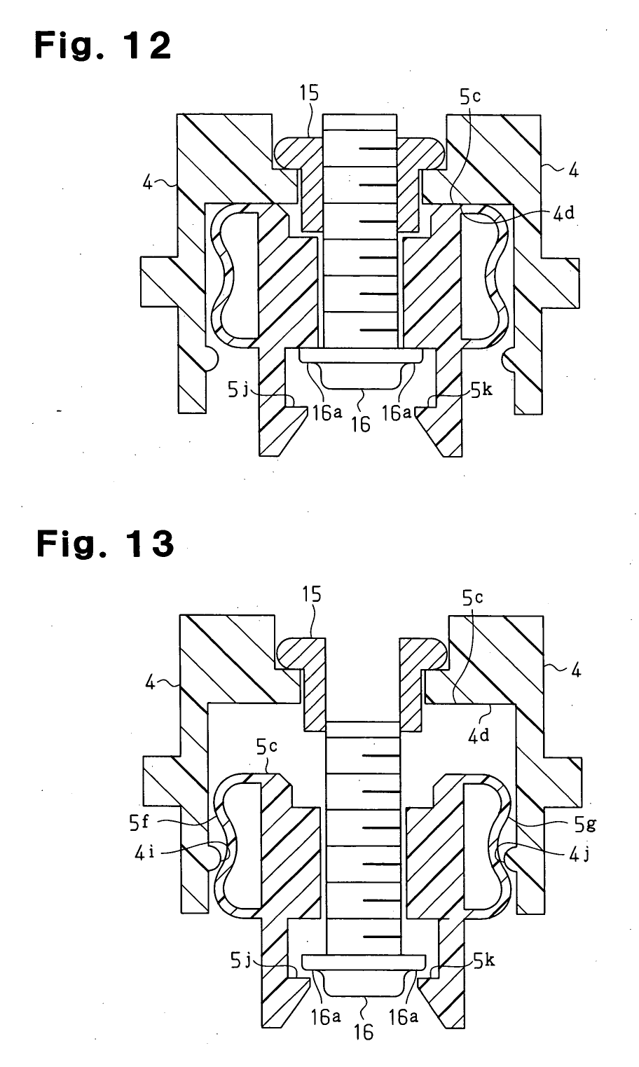

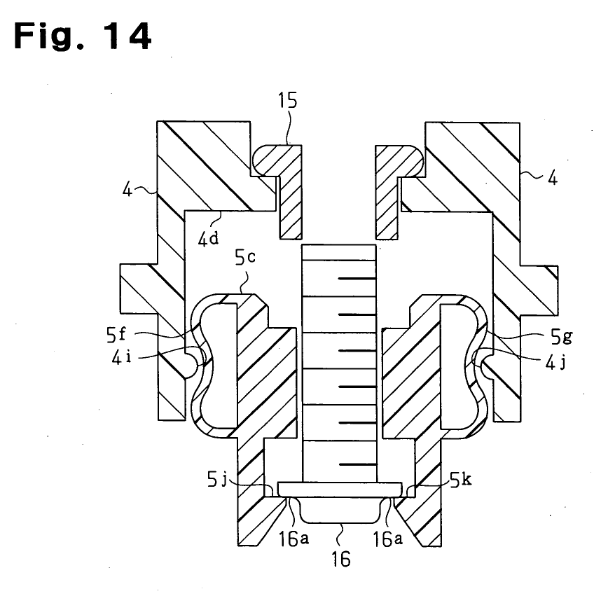

The operation for moving the fastening piece 5 in the fastened state will now be described. When, for example, the handle grip 3 is to be replaced or repaired, the fastening piece 5 in the fastened state must be moved and be set in the tentatively assembled state in which the handle grip 3 is removable. FIG. 12 is a cross-sectional view taken along line B-B of a fixing portion of the fastening piece 5 in the fastened state, and FIGS. 13 and 14 are cross-sectional views taken along line B-B of the fixing portion of the fastening piece 5 in the tentatively assembled state.

To move the fastening piece 5 in the fastened state, the bolt 16 is first rotated in the loosening direction. The nut 15 is fixed to the frame 4. Thus, as the bolt 16 rotates, the bolt 16 moves away from the frame 4 (downward in FIG. 12). When the bolt 16 is moved by a predetermined amount, a contact surface 16a of the bolt 16 comes in contact with engagement portions 5j and 5k arranged on the fastening piece 5. As the bolt 16 continues to move, the fastening piece 5 also moves together with the bolt 16 so that the contact surface 5c of the fastening piece 5 becomes spaced from the contact surface 4d of the frame 4. Then, the fastening piece 5 is moved to the position at which the fastening piece 5 is in the tentatively assembled state shown in FIG. 13. In this state, the handle grip 3 is removable. In this way, the fastening piece 5 is moved from the fastened state to the tentatively assembled state by rotating the bolt 16 in the loosening direction. This eliminates the operation of, for example, removing the fastening piece 5 after loosening the bolt 16, and improves efficiency in assembling processes.

Further, when the bolt 16 is rotated continuously in the loosening direction from the tentatively assembled state shown in FIG. 13, the nut 15 and the bolt 16 that have been fastened together are released as shown in FIG. 14. Here, the projections 4i and 4j of the frame 4 and the temporary attachment recesses 5f and 5g of the fastening piece 5 remain engaged with each other. Thus, the fastening piece 5 remains in the tentatively assembled state. As a result, the fastening piece 5 is prevented from falling off the frame 4 even if the bolt 16 is loosened too much when moving the fastening piece 5.

The operation of the vehicle door handle device 311 will be now described. When the assembling of the vehicle door handle device 311 is completed, the fastening piece 5 is in the fastened state. To open the door 8 of the vehicle, when the door 8 is in the closed state, the handle grip 3 is gripped and pulled outwards of the door 8. The support portion 4c of the frame 4 and the support portions 5a and 5b of the fastening piece 5 pivotally support the pivot shaft 3a of the handle grip 3. Thus, the handle grip 3 starts pivoting about the pivot shaft 3a without becoming loose in the longitudinal direction of the handle grip 3. As the handle grip 3 pivots, the interlocked portion 3b of the handle grip 3 actuates the bell crank arm 14, and the bell crank arm 14 drives the latch mechanism of the door lock mechanism. When the handle grip 3 is pivoted by a predetermined angle, the door lock mechanism is unlocked. This enables the door 8 to open and move in the opening direction.

The above embodiment has the advantages described below.

(1) In the above embodiment, the support portions 5a and 5b of the fastening piece 5 restrict movement of the pivot shaft 3a of the handle grip 3 in the longitudinal direction of the handle grip 3 in the fastened state in which the fastening piece 5 is fixed to the frame 4 by the nut 15 and the bolt 16. Thus, when the assembling of the vehicle door handle device 311 is completed, the handle grip 3 is prevented from becoming loose in the longitudinal direction.

(2) In the above embodiment, in the tentatively assembled state in which the pivot shaft 3a is removable from the frame 4, the fastening piece 5 is held by the frame 4. This enables the fastening piece 5 and the frame 4 to be handled as a single unit before the handle grip 3 is attached. As a result, in the processes of assembling the vehicle door handle device 311, the handle grip 3 is supported just by fastening the bolt 16 after the attachment of the handle grip 3. This improves the operability of the assembling processes. Further, the fastening piece 5 and the frame 4, which form a unit, are also advantageous in their handling during transportation or in their manufacturing management.

(3) In the above embodiments, the fastening piece 5 is supported by the frame 4 in a tentatively assembled state by the engagement of the projections 4i and 4j of the frame 4 and the temporary attachment recesses 5f and 5g of the fastening piece 5. This enables the fastening piece 5 to be held in the tentatively assembled state by the frame 4 without using additional members.

(4) In the above embodiments, the defining walls of the temporary attachment recesses 5f and 5g that are engaged with the projections 4i and 4j of the frame 4 are configured to easily elastically deform. Thus, the fastening piece 5 is held in or released from the tentatively assembled state without applying a large load. In other words, the projections 4i and 4j and the temporary attachment recesses 5f and 5g are disengaged without a large resistance. Thus, the fastening piece 5 is smoothly moved from the tentatively assembled state to the fastened state.

(5) In the above embodiment, when moving the fastening piece 5, which is in the fastened state, the bolt 16 is rotated in the loosening direction to move the bolt 16 in the direction in which the bolt 16 is spaced from the frame 4 so that the contact surface 16a of the bolt 16 comes in contact with the engagement portions 5j and 5k of the fastening piece 5. As a result, the fastening piece 5 is moved from the fastened state to the tentatively assembled state. More specifically, when the bolt 16 (fastening member) is moved as it is loosened, the bolt 16 engages the engagement portions 5j and 5k so that the fastening piece 5 (shaft supporting member) moves together with the bolt 16 from a position corresponding to the fastened state toward a position corresponding to the tentatively assembled state. The fastening piece 5 is moved from the fastened state to the tentatively assembled state simply by rotating the bolt 16 in the loosening direction. As a result, the efficiency of the assembling processes is improved. More specifically, when the fastening piece 5 is moved from the fastened state to, for example, replace the handle grip 3, the fastening piece 5 is moved to the position corresponding to the tentatively assembled state (state in which the handle grip 3 is removable from the frame 4) just by unfastening the bolt 16. This improves the efficiency of the assembling processes.

(6) In the above embodiment, when the bolt 16 is rotated in the loosening direction to move the fastening piece 5 from the fastened state to the tentatively assembled state, the nut 15 and the bolt 16, which are fastened together, are unfastened in the tentatively assembled state of the fastening piece 5. As a result, the fastening piece 5 is prevented from moving to the position at which the fastening piece 5 falls off from the frame 4 even when the bolt 16 is loosened too much.

The above embodiment may be modified in the following forms.

The two support portions 5a and 5b of the fastening piece 5 restrict movement of the pivot shaft 3a in the longitudinal direction in the above embodiments. However, just one of the support portions 5a and 5b may be arranged on the fastening piece 5, and the other one of the support portions may be arranged on the frame 4.

Although the fastening piece 5 is held in a tentatively assembled state by the frame 4 through the engagement of the projections 4i and 4j of the frame 4 with the temporary attachment recesses 5f and 5g of the fastening piece 5 in the above embodiment, the fastening piece 5 may be supported in the tentatively assembled state using a separate member.

Although the fastening piece 5 is fastened to the frame 4 with the nut 15 and the bolt 16 in the fastened state of the fastening piece 5 in the above embodiment, the fastening piece 5 may be fixed through another fastening method. For example, an engagement hook arranged on the fastening piece 5 may be engaged with the frame 4 (refer to the guide portions 50b in FIG. 5).

Although the nut 15 is fixed to the frame 4 in the above embodiment, a female screw portion corresponding to the nut 15 may be arranged directly on the frame 4.

A vehicle door handle device according to a fourth embodiment of the present invention will now be described.

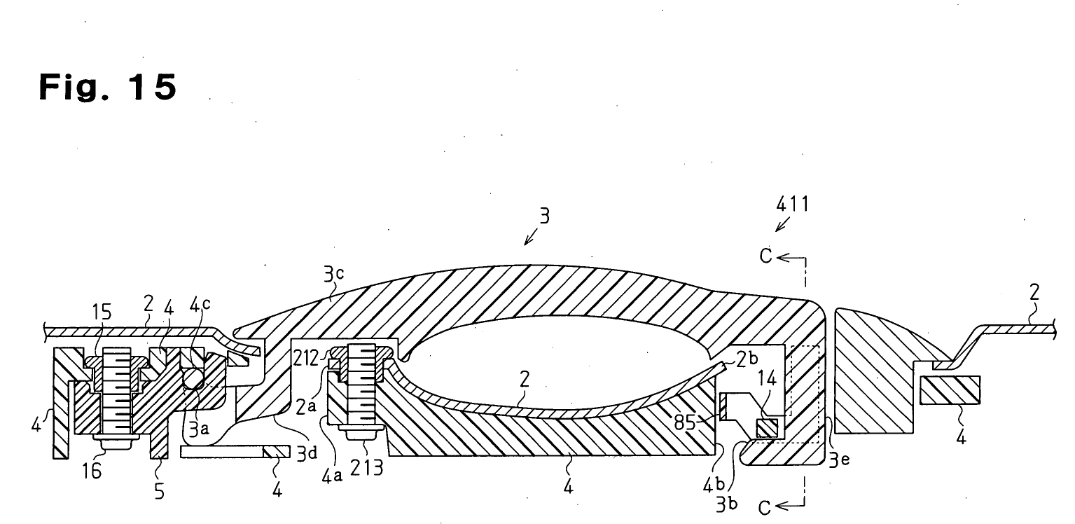

As shown in FIG. 15, a door handle device 411 for a vehicle includes a guide member 85 fixed to a frame 4.

The frame 4 is made of a material having high strength, such as a resin containing glass fibers, to support a handle grip 3.

The guide member 85 is arranged in the vicinity of an opening 4b of the frame 4, and is fixed to the frame 4. The guide member 85 is configured to restrict movement of the handle grip 3 in the axial direction of a pivot shaft 3a by sliding a leg portion 3e of the handle grip 3 when the handle grip 3 is pivoted. For this purpose, the guide member 85 is made of a material having superior sliding characteristics. Further, the guide member 85 is made of a material having hardness that is lower than the material for the frame 4.

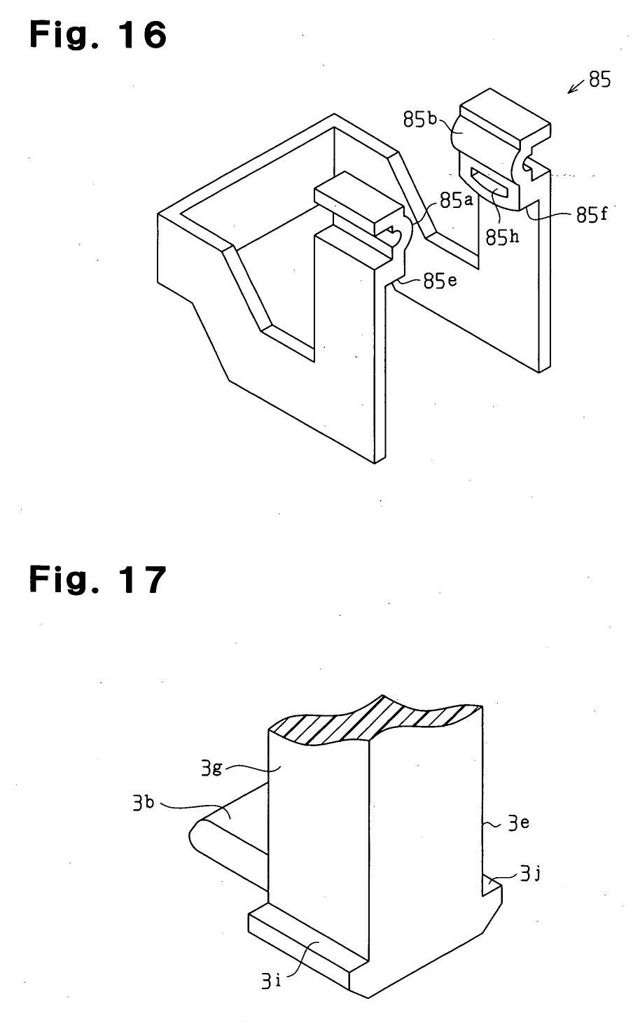

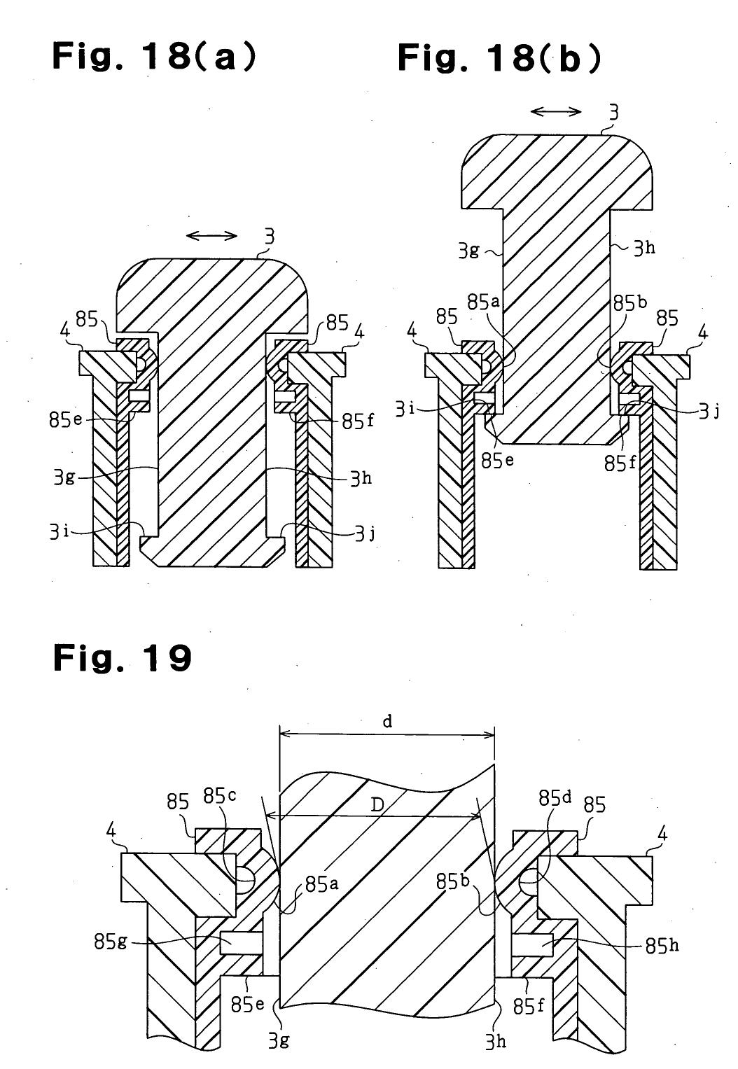

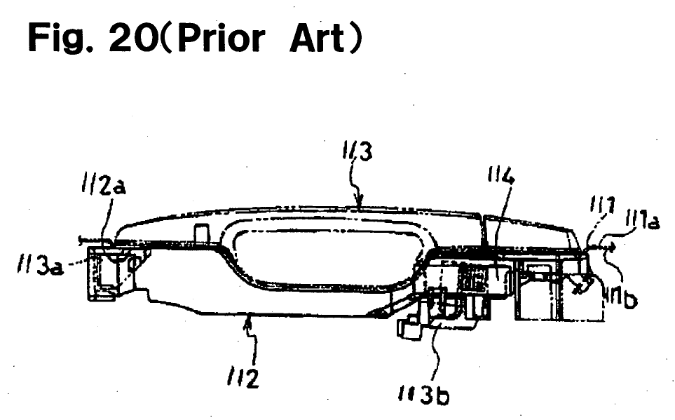

FIG. 16 is a perspective view showing the guide member 85, FIG. 17 is a perspective view showing the leg portion 3e of the handle grip 3, FIG. 18 is a cross-sectional view of the vehicle door handle device 411 taken along line C-C of FIG. 15, and FIG. 19 is a partially enlarged view showing the main part of FIG. 18. FIG. 18(a) is a cross-sectional view of the handle grip 3 taken at a non-operation position, and FIG. 18(b) is a cross-sectional view of the handle grip 3 taken at a pivot end position in the opening operation direction.

The guide member 85, which has a substantially U-shaped outer form, has guide portions 85a and 85b facing each other formed on a pair of opposing inner surfaces. The guide portions 85a and 85b are formed as projections. The guide portions 85a and 85b restrict movement of the handle grip 3 in the axial direction of the pivot shaft 3a (direction indicated by a solid line in FIG. 18) by sliding along slide portions 3g and 3h of the leg portion 3e of the handle grip 3. The distance D between the vertex of the guide portion 85a and the vertex of the guide portion 85b when the handle grip 3 is separated from the guide member 85 (refer to FIG. 19) is set to be smaller than the distance d between the slide portion 3g and the slide portion 3h of the leg portion 3e. Further, hollow portions 85c and 85d are respectively arranged on the rear surfaces of the guide portions 85a and 85b to enable the guide portions 85a and 85b to be easily and elastically deformed outwards. As a result, the guide portions 85a and 85b of the guide member 85 elastically support the leg portion 3e of the handle grip 3 in between and prevents the handle grip 3 from becoming loose in the axial direction of the pivot shaft 3a.

Further, the guide member 85 is configured to restrict the pivot range of the handle grip 3 in the opening operation direction. Contact portions 3i and 3j are arranged on the distal end of the leg portion 3e of the handle grip 3, and stopper portions 85e and 85f are arranged on the guide member 85. As shown in FIG. 18(b), the contact portions 3i and 3j of the handle grip 3 come in contact with the stopper portions 85e and 85f of the guide member 85 at the pivot end position of the handle grip 3 in the opening operation direction to restrict the pivot range of the handle grip 3. Hollow portions 85g and 85h are arranged on the rear side (upper side in FIG. 18) of the stopper portions 85e and 85f of the guide member 85 so that the stopper portions 85e and 85f are configured to be easily and elastically deformed toward the rear. As a result, the contact portions 3i and 3j of the handle grip 3 elastically come in contact with the stopper portions 85e and 85f of the guide member 85 at the pivot end position of the handle grip 3 in the opening operation direction. This reduces the hitting noise of the stopper portions 85e and 85f against the contact portions 3i and 3j.

The operation of the vehicle door handle device 411 will now be described. To open the vehicle door when the vehicle door is in the closed state, the handle grip 3 is gripped and pulled outwards of the vehicle door. Then, the handle grip 3 starts pivoting about the pivot shaft 3a, and the slide portions 3g and 3h of the handle grip 3 start moving while sliding along the guide portions 85a and 85b of the guide member 85 (FIG. 18(a)). As the handle grip 3 pivots, the interlocked portion 3b of the handle grip 3 actuates the bell crank arm 14, and the bell crank arm 14 drives the latch mechanism of the door lock mechanism. When the handle grip 3 is pivoted by a first predetermined angle, the door lock mechanism is unlocked. This enables to door to open.

The handle grip 3 is formed to rotate in the opening operation direction even after the door lock mechanism is unlocked. When the operation to rotate the handle grip 3 in the opening operation direction is continued, the contact portions 3i and 3j of the handle grip 3 come in contact with the stopper portions 85e and 85f of the guide member 85 when the handle grip 3 rotates by a second predetermined angle (FIG. 18(b)). This restricts the range of rotation of the handle grip 3 in the opening operation direction.

The above embodiment has the advantages described below.

(11) In the above embodiment, the contact portions 3i and 3j of the handle grip 3 elastically come in contact with the stopper portions 85e and 85f of the guide member 85 at the pivot end position of the handle grip 3 in the opening operation direction. This reduces the hitting noise of the contact portions 3i and 3j and the stopper portions 85e and 85f generated at the pivot end position.

(12) In the above embodiment, the guide portions 85a and 85b of the guide member 85 elastically support the slide portions 3g and 3h of the handle grip 3 in between to restrict movement of the handle grip 3 in the axial direction of the pivot shaft 3a. Thus, when the handle grip 3 is pivoted, the loosening of the handle grip 3 in the axial direction of the pivot shaft 3a is prevented without applying a large load to the handle grip 3. Further, the guide portions 85a and 85b elastically support the slide portions 3g and 3h in between and variations among products in the distance D between the distal end of the guide portion 85a and the distal end of the guide portion 85b and the distance d between the slide portion 3g and the slide portion 3h of the leg portion 3e are absorbed. Further, the loosening of the handle grip 3 in the axial direction of the pivot shaft 3a is prevented.

(13) In the above embodiment, the guide member 85 for restricting movement of the leg portion 3e of the handle grip 3 in the axial direction of the pivot shaft 3a has the stopper portions 85e and 85f that are easily and elastically deformed. More specifically, the stopper portions 85e and 85f are integrally formed with the guide member 85. This eliminates the need for arranging an additional stopper member for reducing hitting noise and prevents the number of components from increasing.

(14) In the above embodiment, the guide member 85 is made of a material having a lower hardness than the material for the frame 4. Thus, the stopper portions 85e and 85f of the guide member 85 are easily and elastically deformed while the frame 4 is maintained to have high strength. This reduces the hitting noise of the contact portions 3i and 3j and the stopper portions 85e and 84f generated at the pivot end position of the handle grip 3. Further, the guide portions 85a and 85b of the guide member 85 are easily and elastically deformed. This reduces the load applied to the handle grip 3 when the handle grip 3 is pivoted.

(15) In the above embodiment, the frame 4 is made of a material having high strength, and the guide member 85 is made of a material having superior sliding characteristics. This increases the freedom for material selection as compared with when, for example, the frame 4 and the guide member 85 are formed integrally with each other.

(16) The handle grip 3 has the first end, on which the pivot shaft 3a is arranged, and the second end, on which the interlocked portion 3b that is interlocked with the door lock mechanism and the contact portions 3i and 3j that come in contact with the stopper portions 85e and 85f at the pivot end position are arranged. Thus, the pivot shaft 3a, the interlocked portion 3b, and the contact portions 3i and 3j of the handle grip 3 are efficiently arranged.

The above embodiment may be modified in the following forms.

Although the handle grip 3 is a grip type door handle in the above embodiment, the handle grip 3 may be a flap type door handle.

Although the guide member 85 has the two stopper portions 85e and 85f in the above embodiment, the guide member 85 may have one stopper portion or three or more stopper portions.

Although the guide member 85 is made of a material having a lower hardness than the material for the frame 4 in the above embodiment, the materials for the guide member 85 and the frame 4 may be selected without considering hardness of the materials.

Although the guide portions 85a and 85b of the guide member 85 elastically support the slide portions 3g and 3h of the handle grip 3 in between in the above embodiment, gaps may be formed between the guide portions 85a and 85b and the slide portions 3g and 3h.

1. A vehicle door handle device for mounting to a vehicle door panel having front and rear surfaces, the vehicle door handle device comprising: a base member fixable to the rear surface of the door panel and a grip member arranged on the base member from the front surface of the door panel so that the grip member is supported on the base member in a tiltable manner,
a pivot shaft arranged on the grip member; and
a shaft supporting member for supporting the pivot shaft with respect to the base member, wherein the shaft supporting member restricts movement of the pivot shaft in a longitudinal direction of the grip member with respect to the base member.

2. The vehicle door handle device according to claim 1, wherein:
the grip member includes a support arm having a pair of opposing walls facing toward each other, the pivot shaft is arranged on the support arm to connect the opposing walls to each other, and the shaft supporting member is accommodated between the opposing walls.

3. The vehicle door handle device according to claim 1, wherein:
the shaft supporting member has a shaft supporting recess for supporting the pivot shaft in a pivotal manner.

4. The vehicle door handle device according to claim 3, wherein:
a flexible portion capable of contacting the pivot shaft is formed on an inner wall of the shaft supporting recess.

5. The vehicle door handle device according to claim 4, wherein:
the shaft supporting member has a through hole extending around the shaft supporting recess in the same direction as the direction in which the pivot shaft extends, wherein a portion of the shaft supporting member between the through hole and the inner wall of the shaft supporting recess forms the flexible portion.

6. The vehicle door handle device according to claim 4, wherein:
the shaft supporting recess is defined by three inner walls, and the flexible portion is formed on at least one of the three inner walls.

7. The vehicle door handle device according to claim 1, wherein:
the base member has a shaft supporting recess for pivotally supporting the pivot shaft.

8. The vehicle door handle device according to claim 1, wherein:
the pivot shaft is cylindrical and extends in a direction perpendicular to the longitudinal direction of the grip member.

9. The vehicle door handle device according to claim 1, comprising:
a door lock mechanism for locking a vehicle door at a closed position; and
a fastening member for fastening the shaft supporting member to the base member;
wherein when the grip member is pivoted from a state in which the vehicle door is closed, the door lock mechanism is unlocked to permit the vehicle door to open;
the pivot shaft extends substantially vertically with respect to the longitudinal direction of the grip member;
the shaft supporting member is capable of shifting between a fastened state in which the shaft supporting member is fastened to the base member by the fastening member and a tentatively assembled state in which the shaft supporting member is tentatively attached to the base member and held by the base member at a position separated from a position at which the shaft supporting member is fastened to the base member, and
the shaft supporting member restricts movement of the pivot shaft in the longitudinal direction of the grip member in the fastened state and permits the pivot shaft to be attached to and detached from the base member in the tentatively assembled state.

10. The vehicle door handle device according to claim 9, wherein:
one of the base member and the shaft supporting member includes a projection, and the other one of the base member and the shaft supporting member has a wall defining a temporary attachment recess, wherein the projection is engaged with the temporary attachment recess so that the base member holds the shaft supporting member in the tentatively assembled state, and the wall defining the temporary attachment recess is elastically deformable.

11. The vehicle door handle device according to claim 9, wherein:
the shaft supporting member has an engagement portion engageable with the fastening member to restrict separation of the fastening member from the shaft supporting member.

12. The vehicle door handle device according to claim 11, wherein:
the fastening member is a male screw member, and the base member has a female screw portion fastened with the male screw member, wherein when moving the fastening member while loosening the fastening member, the fastening member is engaged with the engagement portion so that the shaft supporting member moves together with the fastening member toward a position corresponding to the tentatively assembled state.

13. The vehicle door handle device according to claim 12, wherein:
the male screw member and the female screw portion are disengageable when the shaft supporting member is temporarily attached to the base member.

14. The vehicle door handle device according to claim 1, comprising:
a guide member fixed to the base member, wherein the guide member guides the grip member so that the grip member slides when pivoted and restricts movement of the grip member in an axial direction of the pivot shaft, and the guide member includes a stopper portion that elastically comes in contact with the grip member and restricts further pivoting of the grip member when the grip member is pivoted to a pivot end position in a direction in which the vehicle door opens.

15. The vehicle door handle device according to claim 14, wherein:
the guide member elastically holds the grip member to restrict movement of the grip member in the axial direction of the pivot shaft.

16. The vehicle door handle device according to claim 14, wherein:
the guide member is made of a material having a lower hardness than a material for the base member.

17. The vehicle door handle device according to claim 14, wherein:
the grip member has a first end and a second end, and the pivot shaft is arranged on the first end, and an interlocked portion interlocked with a door lock mechanism and a contact portion that comes in contact with the stopper portion at the pivot end position are arranged on the second end.
